(19) United States
(12) Patent Application Publication
(10) Pub. No.: US 2020/0181461 A1
(43) Pub. Date: Jun. 11, 2020

(54) Adhesive Articles

(71) Applicant: Avery Dennison Corporation, Glendale, CA (US)

(72) Inventors: David J. SHUEY, Cleveland, OH (US); Robert W. SCHNEIDER, Chardon, OH (US); Eric M. BILDSTEIN, Mentor, OH (US)

(21) Appl. No.: 16/312,432

(22) PCT Filed: Jun. 22, 2017
(86) PCT No.: PCT/US17/38705

§ 371 Date: Dec. 21, 2018

Related U.S. Application Data
(60) Provisional application No. 62/354,933, filed on Jun. 27, 2016.

(51) Int. Cl. C09J 7/38; C09J 7/25; C09J 7/21; E04F 15/02

(52) U.S. Cl. CPC C09J 7/385; C09J 7/38; C09J 7/383; C09J 7/255; C09J 7/21; E04F 15/02155; C09J 2203/314; C09J 2467/006; C09J 2433/00; C09J 2421/00; C09J 2475/00; C09J 2483/00; C09J 2400/283

(57) ABSTRACT

Adhesive articles such as flexible tapes are described. The adhesive articles include oppositely directed faces of adhesives that are suited for adhesive applications for laminating flooring materials and other construction applications.

### FIELD

The present subject matter relates to adhesive articles exhibiting particular combinations of adhesive properties. The articles can be in the form of adhesive tapes and find wide application in construction and flooring applications.

### BACKGROUND

Adhesive tapes and particularly double-sided adhesive tapes have long been used for adhering carpet and flooring materials to an underlying subfloor. Although satisfactory in certain respects, currently known tapes do not adequately provide sufficient holding power and/or desired characteristics. Thus, bonding between the tape and one or more adjacent surfaces, especially surfaces comprising different materials, is deficient and/or compromised as a result of the tape adhesive satisfying only a portion of the installation demands. Accordingly, a need exists for improved tapes which provide significant holding power and a superior balance of adhesive properties.

### SUMMARY

The difficulties and drawbacks associated with previous approaches are addressed in the present subject matter as follows.

In one aspect, the present subject matter provides an adhesive article comprising a carrier defining a first face and a second face, wherein the second face is oppositely directed from the first face. The adhesive article also comprises a first adhesive layer at least partially disposed on the first face, and a second adhesive layer at least partially disposed on the second face. In some implementations, the adhesive of the second adhesive layer may be compositionally different than the composition of the adhesive of the first adhesive layer. In some implementations, the adhesive of the second adhesive layer may be the same as the composition of the adhesive of the first adhesive layer. The adhesive article may be uniquely adapted for laminating flooring materials or other construction applications due in large part to certain properties of the adhesives used in the adhesive articles. The adhesive article may additionally comprise one or more release liners.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is a schematic illustration of one embodiment of an adhesive article in roll form, in accordance with an embodiment of the present subject matter.

FIG. 2 is a schematic cross sectional view of the adhesive article depicted in FIG. 1.

FIG. 3 is a schematic cross sectional view of another embodiment of the adhesive article.

### DETAILED DESCRIPTION OF THE EMBODIMENTS

The adhesive articles of the present subject matter exhibit a unique combination of properties. In many embodiments, the articles are in the form of adhesive tapes and comprise adhesives that exhibit a particular combination of adhesive properties. In certain embodiments, the adhesive properties include (i) a particular range of adhesion as determined by peel adhesion testing defined by PSTC-3/ASTM-D 3330, as tested under TAPPI conditions, (ii) a particular range of tack as determined by loop tack testing defined by ASTM D6195, as tested under TAPPI conditions, and/or (iii) a particular range of shear as determined by shear testing defined by PSTC-7/ASTM-D 1000, as tested under TAPPI conditions.

The unique combination of adhesion, tack, and shear, exhibited by many embodiments of adhesive articles of the present subject matter may result in significant holding power of the adhesive articles and construction applications, including a flooring material to a subfloor. Many embodiments of adhesive articles of the present subject matter may allow adhesion of dissimilar substrates (also referred to as materials). The adhesive article described herein may prevent or limit flooring materials and other construction materials from lifting from or sliding against a subfloor or other construction material. The adhesive article described herein may prevent or limit flooring materials and other construction materials from grooving on a subfloor or other construction material.

As described herein, the flooring material may include, but is not limited to laminate flooring material, vinyl tile, tile (ceramic, marble, travertine, glass, stone, slate, or other tile materials), and carpet and carpet tiles. The subfloor may be comprised of, but is not limited to wood, metal, concrete, cement, and composite materials.

In many embodiments, the present subject matter may provide a double sided adhesive tape having two layers of different adhesives. That is, the adhesives are compositionally different from each other. The double sided tapes may find use in a wide range of applications including adhering flooring materials to subfloors and other construction applications. Two versions of the tape are contemplated including a single liner tape product, and a double liner tape product. The tapes may include a carrier, two adhesive layers, and at least liner. The tapes may comprise adhesives that exhibit particular combination(s) of adhesive properties that may enable the tapes to be used in challenging adhesive applications such as flooring materials and other construction applications.

In other embodiments, the present subject matter may provide a double sided adhesive tape having two layers of the same adhesives. That is, the adhesives are compositionally the same as each other. The double sided tapes may find use in a wide range of applications including flooring materials to subfloors and other construction applications. Two versions of the tape are contemplated including a single liner tape product, and a double liner tape product. The tape may include a carrier, two adhesive layers, and at least one liner. The tape may comprise adhesives that exhibit particular combination(s) of adhesive properties that may enable the tapes to be used in challenging adhesive applications such as flooring materials and other construction applications.

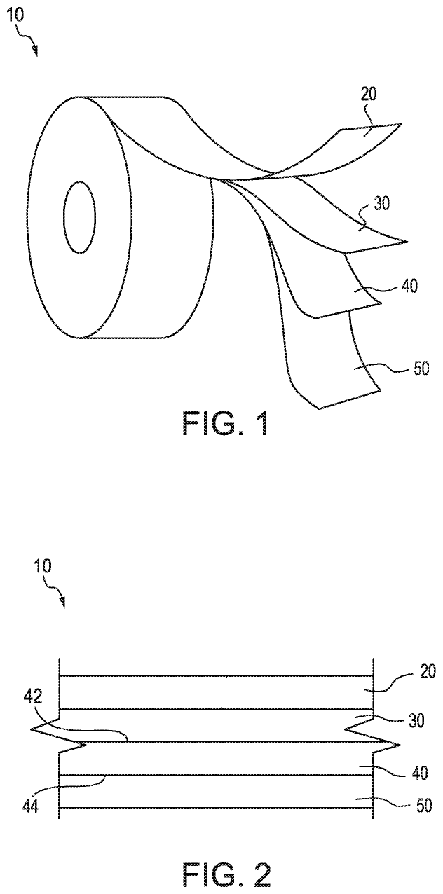

FIG. 1 is a schematic illustration of a tape in roll form having an end section of the tape “exploded” for ease in describing each layer and other aspect(s) of the tape 10. The tape 10 may comprise at least one release liner 20, a first adhesive layer 30, a carrier 30, and a second adhesive layer 50.

FIG. 2 is a schematic cross sectional view of the tape of FIG. 1. The tape 10 generally comprises a carrier 40 defining oppositely directed first face 42 and second face 44, respectively. The tape 10 also comprises a first adhesive layer 30 at least partially disposed on the “liner side” of the carrier 40, i.e., along first face 42, and a second adhesive layer 50 at least partially disposed on the “unwind side” of the carrier 40, i.e., along second face 44. In FIG. 2, the first adhesive layer 30 and the second adhesive layer 50 comprise different adhesive compositions. The tape 10 may additionally comprise at least one release liner 20 at least partially disposed along the first adhesive layer 30. In such embodiments, the tape 10 is in the form of a single liner tape. In other embodiments, a secondary liner can be provided along the second adhesive layer 50. In those versions, the tape is in the form of a double liner tape.

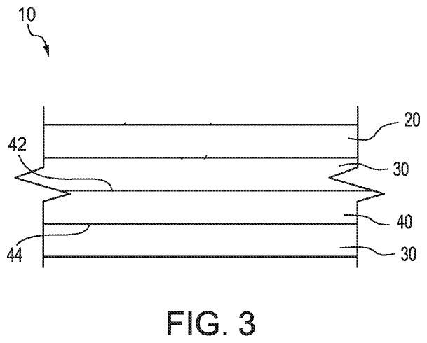

FIG. 3 provides another embodiment of the present subject matter. In many embodiments, the present subject matter may provide a tape 10 having a first adhesive layer 30 and a second adhesive layer 50 wherein the first adhesive layer 30 and a second adhesive layer 50 are the same adhesive. That is, the first adhesive layer 30 and a second adhesive layer 50 are compositionally the same as one another. The tape 10 generally comprises a carrier 40 defining oppositely directed first face 42 and second face 44, respectively. The tape 10 also comprises the first adhesive layer 30 at least partially disposed on the “liner side” of the carrier 40, i.e., along first face 42, and the second adhesive layer 50 at least partially disposed on the “unwind side” of the carrier 40, i.e., along second face 44. The tape 10 may additionally comprise at least one release liner 20 at least partially disposed along the first adhesive layer 30. In such embodiments, the tape 10 is in the form of a single liner tape. In other embodiments, a secondary liner can be provided along the second adhesive layer 50. In those versions, the tape is in the form of a double liner tape. The tape 10 may find use in a wide range of applications including flooring materials to subfloors. Two versions of the tape 10 may be provided, including: 1) a single liner tape product, and 2) a double liner tape product that may include a carrier with two adhesive layers. The tape 10 may comprise adhesives that may exhibit particular combination(s) of adhesive properties that enable the tapes to be used in challenging adhesive applications such as flooring materials and other construction applications.

For the double sided adhesive tape having two layers of the same adhesive, construction of the tape may vary. In one embodiment, the first adhesive layer 30 and the second adhesive layer 50 where the first adhesive layer 30 and the second adhesive layer 50 comprise the same composition, the first adhesive layer 30 and the second adhesive layer 50 may be at least partially disposed on both sides of the carrier 40.

For the tape described herein, a wide array of materials can be used for the carrier 40. The carrier can be a permeable or nonpermeable material. A nonlimiting representative listing of such suitable carrier materials includes scrim, nonwoven materials, paper, films, and combinations thereof. In many embodiments, the carrier includes one or more polymeric films such as for example polyethylene terephthalate (PET). In many embodiments, the carrier may be flexible.

The first adhesive layer 30 should be compatible with smooth to rough materials which are typically concrete, wood, and other flooring materials. A wide range of adhesives can be used for the first adhesive layer 30. In one embodiment, emulsion adhesives may be used. In another embodiment, acrylic adhesives may be used. The acrylic adhesives may have low contents of volatile organic compounds (VOC's). In other embodiments, the first adhesive layer 30 may comprise acrylic adhesives, rubber-based adhesives, polyurethane-based adhesives, silicone-based adhesives, and combinations thereof. The first adhesive layer 30 may comprise a pressure sensitive adhesive. In another embodiment, the first adhesive layer 30 may comprise a heat activated adhesive. The first adhesive layer 30 can be provided in a range of thicknesses. The thickness of the first adhesive layer 30 may be from about 0.25 mil (6.3 microns) to about 8 mil (203.2 microns). The thickness of the first adhesive layer 30 may also be from about 2.0 mil (50.8 microns) to about 4.0 mil (101.6 microns).

A variety of adhesives can be used for the second adhesive layer 50. The second adhesive layer 50 typically exhibits characteristics such that the adhesive can bond to flooring materials such as polyvinyl chloride (PVC) laminate flooring materials. In many embodiments, the second adhesive layer 50 may be resistant to plasticizer that is typically contained in PVC laminate flooring materials. In certain embodiments, the second adhesive layer 50 is a high performance acrylic adhesive. The acrylic adhesives may have low contents of volatile organic compounds (VOC's). In other embodiments, the second adhesive layer 50 may comprise acrylic adhesives, rubber-based adhesives, polyurethane-based adhesives, silicone-based adhesives, and combinations thereof. The second adhesive layer 50 may comprise a pressure sensitive adhesive. In another embodiment, the second adhesive layer 50 may comprise a heat activated adhesive. The second adhesive layer 50 can be provided in a range of thicknesses. The thickness of the second adhesive layer 50 may be from about 0.25 mil (6.3 microns) to about 8 mil (203.2 microns). The thickness of the second adhesive layer 50 may also be from about 2 mil (50.8 microns) to about 4 mil (101.6 microns).

The release liner 20 is generally a tear resistant and moisture resistant or moisture proof material such as a film material and/or a heavy basis weight kraft paper. The release liner 20 may be comprised of a film material, a paper material, and combinations thereof A nonlimiting example of a suitable film material for the release liner 20 is polyethylene terephthalate (PET) paper with an appropriate release coating. Another nonlimiting example of a suitable film material for the release liner 20 is a silicone release liner. Another nonlimiting example of a suitable paper material for the release liner 20 is heavy basis weight kraft paper with an appropriate release coating.

In certain embodiments, the adhesive articles such as the tapes described herein include one or more migration coating(s). The migration coating(s) can be included in the tapes to prevent or at least reduce the occurrence of one or more agent(s) in an adhesive layer migrating into the other adhesive layer or other components or regions of the tape. It is also contemplated that the adhesive article such as a tape could be provided in a carrier-free form and thus not include a carrier such as carrier 20. In such versions, one or more migration coating(s) can be provided between the first adhesive layer 30 and the second adhesive layer 50, for example.

In certain embodiments, the tapes include a first adhesive layer 30 which exhibits particular properties. In other embodiments, the tapes include a second adhesive layer 50 which exhibits particular properties. And in still other embodiments, the tapes include a first adhesive layer 30 which exhibits particular properties in combination with a second adhesive layer 50 that exhibits particular properties.

In particular embodiments, the first adhesive layer 30 and/or second adhesive layer 50 exhibit certain peel adhesion values. As previously noted, peel adhesion is determined according to PSTC-3/ASTM-D 3330. The peel adhesion values referred to herein are composite values which are the average of six (6) measurements involving testing substrates of stainless steel (SS), DuRock (a brand of cement backer board available from US Gypsum Co.), LVT (luxury vinyl tile) (smooth), roll vinyl (polymeric plasticized PVC), rubber tile, and wood veneer (3 ply white birch faced construction). In particular embodiments, the first adhesive layer 30 and/or second adhesive layer 50 may exhibit 180 degree peel adhesion within a range of from about 4.5 N/25.4 mm to about 40.1 N/25.4 mm (about 1.0 lb/in to about 9.0 lb/in) for a 15 minute dwell period. In other embodiments, the first adhesive layer 30 and/or second adhesive layer 50 may exhibit 180 degree peel adhesion within a range of from about 13.3 N/25.4 mm to about 31.1 N/25.4 mm (about 3.0 lb/in to about 7.0 lb/in) for a 15 minute dwell period. The first adhesive layer and/or second adhesive layer may exhibit 180 degree peel adhesion within a range of from about 8.9 N/25.4 mm to about 44.5 N/25.4 mm (about 2.0 lb/in to about 10.0 lb/in) for a 24 hour dwell period on stainless steel. In one embodiment, the first adhesive layer and/or second adhesive layer may exhibit 180 degree peel adhesion within a range of from about 15.6 N/25.4 mm to about 31.1N/25.4 mm (about 3.5 lb/in to about 7.0 lb/in) for a 24 hour dwell period on stainless steel. In one embodiment, the first adhesive layer and/or second adhesive layer may exhibit 180 degree peel adhesion within a range of from about 17.8 N/25.4 mm to about 24.5N/25.4 mm (about 4.0 lb/in to about 5.5 lb/in) for a 24 hour dwell period on stainless steel. Additionally, the first adhesive layer 30 and/or second adhesive layer may exhibit 180 degree peel adhesion % changes (initial versus 24 hour dwell) within a range of about 10% to about 50%. In one embodiment, the first adhesive layer 30 and/or second adhesive layer 50 may exhibit 180 degree peel adhesion % changes (initial versus 24 hour dwell) within a range of about 18% to about 41%.

In particular embodiments, first adhesive layer 30 and/or second adhesive layer 50 may exhibit certain loop tack values. As previously noted, loop tack is determined by ASTM D6195. The loop tack values referred to herein are composite values which are the average of the six (6) previously noted typical flooring materials. In particular embodiments, the first adhesive layer 30 and/or second adhesive layer 50 may exhibit loop tack within a range of from about 2.2 N/25.4 mm to about 35.6 N/25.4 mm (about 0.5 lb/in to about 8.0 lb/in). In another embodiment, the first adhesive layer 30 and/or second adhesive layer 50 may exhibit loop tack within a range of from about 13.4 N/25.4 mm to about 31.1 N/25.4 mm (about 3.0 lb/in to about 7.0 lb/in).

In particular embodiments, the first adhesive layer 30 and/or second adhesive layer 50 may exhibit certain dynamic shear values. As previously reported, dynamic shear is determined by laminating 25.4 mm×25.4 mm adhesive square to two panels using a 20N hand roller to roll down the sample five times each direction. The samples are dwelled for 24 hours and pulled apart on an MTS unit at a rate of 2.2 N/25.4 mm. The shear values reported herein are composite values which are the average of the six (6) previously noted typical flooring materials. In certain embodiments, the first adhesive layer 30 and/or second adhesive layer 50 may exhibit shear within a range of from about 22.2 N/25.4 mm to about 289.1 N/25.4 mm as measured in peak N to failure (645.2 sq. mm) (about 5 to about 65 peak lbs to failure). In another embodiment, the first adhesive layer 30 and/or second adhesive layer 50 may exhibit shear within a range of from about 44.5 N/25.4 mm to about 111.2 N/25.4 mm (about 10 to about 25 peak lbs) for a Durock/LVT laminate.

Although a wide variety of adhesive types can potentially be used in either or both of the adhesive layers (first adhesive layer 30 and second adhesive layer 50), in many embodiments the adhesives are both pressure sensitive adhesives (PSA). However, the present subject matter includes a wide array of other types of adhesives such as but not including structural adhesives, curable adhesives, repositionable adhesives, removable adhesives, and permanent adhesives.

In additional embodiments, the first adhesive layer 30 and/or second adhesive layer 50 can be patterned. It is also contemplated that only portions of regions of the first adhesive layer 30 and second adhesive layer 50 may be patterned. Patterning may be used to impart desired characteristics or functions to the tape or faces thereof of such as for example selective air egress. Patterning of adhesive layers is described in one or more of U.S. Pat. Nos. 8,084,124; 6,630,049; 7,060,351; 7,820,288; 8,252,403; 7,344,618; 7,332,205; 8,252,407; 8,309,207; and 9,240,131 for example.

It is also contemplated that one or both of the adhesive layers may include a plurality of adhesive sublayers or other regions of non-homogeneity.

The adhesive articles can be provided in a variety of different forms and configurations. As noted, in many embodiments, the articles are in the form of tapes and are in roll form, a folded form such as a Z-form, or in a strip form. It is also contemplated that the tapes can be provided with other articles such as for example with flooring materials.

In many instances, the adhesive articles are die cuttable and slittable so they are easily processed. The adhesive articles in many embodiments are plasticizer resistant, moisture resistant, pH resistant, deflection resistant, chemical resistant, and/or heat stable.

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. An adhesive article comprising:
a carrier defining a first face and a second face, wherein the second face is oppositely directed from the first face;
a first adhesive layer at least partially disposed on the first face;
a second adhesive layer at least partially disposed on the second face;
wherein the adhesive article is at least partially disposed between a flooring material and a subfloor.

2. The adhesive article of claim 1, wherein the adhesive of the second adhesive layer is compositionally different than the adhesive of the first adhesive layer.

3. The adhesive article of claim 1, wherein the adhesive of the second adhesive layer is compositionally the same as the adhesive of the first adhesive layer.

4. The adhesive article of claim 1 further comprising:
a release liner at least partially disposed on and at least partially covering at least one of the first adhesive layer and the second adhesive layer.

5. The adhesive article of claim 1 further comprising:
a first release liner at least partially disposed on the first adhesive layer; and
a second release liner at least partially disposed on the second adhesive layer.

6. The adhesive article of claim 1 wherein the carrier includes a material selected from the group comprising scrim, nonwoven materials, paper, films, and combinations thereof.

7. The adhesive article of claim 6 wherein the carrier comprises polyethylene terephthalate (PET).

8. The adhesive article of claim 1 wherein the first adhesive layer comprises at least one adhesive of acrylic adhesives, rubber-based adhesives, polyurethane-based adhesives, silicone-based adhesives.

9. The adhesive article of claim 1 wherein the first adhesive layer comprises an emulsion adhesive.

10. The adhesive article of claim 1 wherein the first adhesive layer has a thickness within a range of from about 6.3 microns to about 203.2 microns.

11. The adhesive article of claim 10 wherein the first adhesive layer has a thickness within a range of from about 50.8 microns to about 101.6 microns.

12. The adhesive article of claim 1 wherein the second adhesive layer comprises at least one adhesive of acrylic adhesives, rubber-based adhesives, polyurethane-based adhesives, silicone-based adhesives.

13. The adhesive article of claim 10 wherein the second adhesive layer comprises a high performance acrylic adhesive.

14. The adhesive article of claim 1 wherein the second adhesive layer has a thickness within a range of from about 6.3 microns to about 203.2 microns.

15. The adhesive article of claim 14 wherein the thickness of the second adhesive layer is about 50.8 microns to about 101.6 microns.

16. The adhesive article of claim 1 wherein the release liner comprises a film material, a paper material, and combinations thereof.

17. The adhesive article of claim 16, wherein the film material is polyethylene terephthalate (PET).

18. The adhesive article of claim 16, wherein the paper material is heavy basis weight kraft paper.

19. The adhesive article of claim 1 wherein the adhesive of at least one of the first adhesive layer and the second adhesive layer exhibits a 180 degree peel adhesion within a range of from about 4.5 N/25.4 mm to about 40.1 N/25.4 mm for a 15 minute dwell period.

20. The adhesive article of claim 19 wherein the adhesive of at least one of the first adhesive layer and the second adhesive layer exhibits a 180 degree peel adhesion within a range of from about 13.3 N/25.4 mm to about 31.1N/25.4 mm for a 15 minute dwell period.

22. The adhesive article of claim 1 wherein the adhesive of at least one of the first adhesive layer and the second adhesive layer exhibits a 180 degree peel adhesion within a range of from about 8.9 N/25.4 mm to about 44.5 N/25.4 mm for a 24 hour dwell period.

23. The adhesive article of claim 22 wherein the adhesive of at least one of the first adhesive layer and the second adhesive layer exhibits a 180 degree peel adhesion within a range of from about 15.6 N/25.4 mm to about 31.1N/25.4 mm for a 24 hour dwell period.

24. The adhesive article of claim 22 wherein the adhesive of at least one of the first adhesive layer and the second adhesive layer exhibits a 180 degree peel adhesion within a range of from about 17.8 N/25.4 mm to about 24.5N/25.4 mm for a 24 hour dwell period.

25. The adhesive article of claim 1 wherein the adhesive of at least one of the first adhesive layer and the second adhesive layer exhibits a loop tack within a range of from about 2.2 N/25.4 mm to about 35.6 N/25.4 mm.

26. The adhesive article of claim 25 wherein the adhesive of at least one of the first adhesive layer and the second adhesive layer exhibits a loop tack within a range of from about 13.4 N/25.4 mm to about 31.1 N/25.4 mm.

27. The adhesive article of claim 1 wherein the adhesive of at least one of the first adhesive layer and the second adhesive layer exhibits a shear within a range of from about 22.2 N/25.4 mm to about 289.1 N/25.4 mm as measured in peak N to failure (645.2 sq. mm).

28. The adhesive article of claim 27 wherein the adhesive of at least one of the first adhesive layer and the second adhesive layer exhibits a shear within a range of from about 44.5 N/25.4 mm to about 111.2 N/25.4 mm as measured in peak N to failure (645.2 sq. mm).

29. The adhesive article of claim 1 wherein at least one of the first adhesive layer and the second adhesive layer includes at least a layer portion that is patterned.

30. The adhesive article of claim 1 wherein the adhesive article is an adhesive tape.

31. The adhesive article of claim 30 wherein the adhesive tape is in roll form.
